(19) United States
(12) Patent Application Publication
(10) Pub. No.: US 2013/0280064 A1
(43) Pub. Date: Oct. 24, 2013

(54) WIND TURBINE WITH ADJUSTABLE DAMPER

(71) Applicant: Sjoerd van STEINVOREN, Enschede (NL)

(72) Inventor: Sjoerd van STEINVOREN, Enschede (NL)

(21) Appl. No.: 13/449,350

(22) Filed: Apr. 18, 2012

(51) Int. Cl. F03D 11/00

(52) U.S. Cl. 416/1; 416/145

(57) ABSTRACT

A wind turbine is provided, comprising a rotor arranged at a nacelle, the nacelle supported by a tower, and a damper including a movable mass. The damper is adapted for variably adjusting a frequency response of the wind turbine.

### BACKGROUND OF THE INVENTION

The subject matter described herein relates generally to methods and systems for wind turbines, and more particularly, to methods and systems for damping oscillations of wind turbines.

At least some known wind turbines include a tower and a nacelle mounted on the tower. A rotor is rotatably mounted to the nacelle and is coupled to a generator by a shaft. A plurality of blades extend from the rotor. The blades are oriented such that wind passing over the blades turns the rotor and rotates the shaft, thereby driving the generator to generate electricity.

Oscillations of wind turbines, for example the periodic bending of the tower, can cause fatigue of wind turbine components, therefore systems and methods of reducing oscillations of wind turbines are implemented. Typically, systems and methods that reduce oscillations and associated fatigue of wind turbine components have disadvantages such as reducing annual energy production of wind turbines, or being costly. For example, methods to reduce oscillations of wind turbines can include forbidding the operation of the wind turbine at some operational frequencies that are near a natural frequency of the tower, which may reduce the risk of oscillation induced damage, but also compromise the energy production of the wind turbine.

### BRIEF DESCRIPTION OF THE INVENTION

In one aspect, a wind turbine is provided, including a rotor arranged at a nacelle, the nacelle supported by a tower, and a damper which includes a movable mass. The damper is adapted for variably adjusting a frequency response of the wind turbine.

In another aspect, a wind turbine is provided, including a rotor arranged at a nacelle, the nacelle supported by a tower, and a damper including a movable mass and a stiffness adjustment mechanism.

In yet another aspect, a method of operating a wind turbine is provided, including operating the wind turbine at an operational frequency; comparing the operational frequency to a reference frequency to form a comparison; and adjusting a damper according to the comparison.

Further aspects, advantages and features of the present invention are apparent from the dependent claims, the description and the accompanying drawings.

### BRIEF DESCRIPTION OF THE DRAWINGS

A full and enabling disclosure including the best mode thereof, to one of ordinary skill in the art, is set forth more particularly in the remainder of the specification, including reference to the accompanying figures wherein:

FIG. 1 is a perspective view of an exemplary wind turbine.

FIG. 2 is an enlarged sectional view of a portion of the wind turbine shown in FIG. 1.

FIG. 3 is an illustrative model of a wind turbine, according to embodiments described herein.

FIG. 4 is an illustration of a frequency response curve of a modeled wind turbine tower, according to embodiments described herein.

FIG. 5 is an exemplary wind turbine including a damper, according to embodiments described herein.

FIG. 6 is an illustrative model of a damped wind turbine, according to embodiments described herein.

FIG. 7 is an illustration of a frequency response curve of a damped wind turbine, according to embodiments described herein.

FIG. 8 is an illustrative model of a damped wind turbine with a stiffness adjustment mechanism, according to embodiments described herein.

FIG. 9 is an illustration of frequency response curves, according to various models of wind turbines.

FIG. 10 is an illustrative model of a liquid damped wind turbine, according to embodiments described herein.

FIG. 11 is an illustrative model of a liquid damped wind turbine, according to embodiments described herein.

FIG. 12 is a portion of a liquid damped wind turbine, according to embodiments described herein.

FIGS. 13-16 are portions of a liquid damped wind turbine, according to embodiments described herein.

FIG. 17-21 are portions of exemplary wind turbines that include a damper, according to embodiments described herein.

FIG. 22 is a schematic of a method of operating a wind turbine, according to embodiments described herein.

FIG. 23 is an illustration of frequency response curves, according to various models of wind turbines.

### DETAILED DESCRIPTION OF THE INVENTION

Reference will now be made in detail to the various embodiments, one or more examples of which are illustrated in each figure. Each example is provided by way of explanation and is not meant as a limitation. For example, features illustrated or described as part of one embodiment can be used on or in conjunction with other embodiments to yield yet further embodiments. It is intended that the present disclosure includes such modifications and variations.

Embodiments described herein include a wind turbine that allows for greater annual energy production, reduced risk of fatigue and fatigue induced failure, reduced oscillations which can cause fatigue, and combinations thereof. Embodiments described herein result in a combined effect of allowing a wind turbine to operate within a broader range of operational frequencies, and at reducing undesirable frequency response of fatiguing periodic and/or oscillatory motion of the wind turbine, for example oscillations of the tower. By providing for an adjustable damper, the disadvantageous effects of previously forbidden operational frequencies which increased fatigue and increased the risk of fatigue induced failure, especially in comparison to previously allowed operational frequencies, are reduced and/or removed. By broadening the range of possible operational frequencies, energy production is increased, and without the deleterious effects of operating for example near resonance modes of the wind turbine, e.g. the tower's natural frequency of bending.

As used herein, the term “operational frequency” is intended to be representative of frequencies such as for example: the frequency of rotation of the rotor which is referred to as the 1 P frequency; the blade-passing frequency which may be referred to as the 3 P frequency in the case of 3-bladed rotors; and other harmonics such as 2 P, 4 P, 5 P and so on. Harmonics can be associated, although it is not necessary, with rotors with an arbitrary number of blades such as the 2 P frequency of a 2-bladed rotor. As used herein, the term “dashpot” is intended to be representative of an energy dissipating device, such as a viscous type dashpot, viscoelastic element, and/or eddy current damper. Herein the expression “more freely oscillating” is used interchangeably with “less damped.” Herein, “peak of response” is used interchangeably with “resonance peak” and “response peak” and can be synonymous with a “resonance,” As used herein, a “resonance” may have a width, or range of frequencies enveloping a response maximum and/or response peak, the resonance rising above the baseline of a response. Herein, a “natural frequency” can be an example of a resonance or resonance peak, and vice versa; “natural frequency” can refer to the natural frequency of the wind turbine, particularly a natural tower frequency, more particularly the first lateral bending frequency of the wind turbine or tower, although other oscillatory modes, particularly of the tower, are also contemplated. Herein, “stiffness” is used as meaning the inverse of “compliance” and vice versa. Alternatively or additionally, “stiffness” can relate to the mobility of a movable mass of a liquid, where more stiff corresponds to less mobility of the liquid. Herein, “forbidden” frequencies are intended to include frequencies, especially operational frequencies, that may normally lead to more fatigue, vibrations, and/or oscillations, for example of the tower. “Forbidden” frequencies are typical of frequencies at or near a resonance, such as the fundamental mode of the tower of the wind turbine. “Forbidden” frequencies can be operational frequencies that are seldom in operation, or are never in operation, or are less often in operation, for example in comparison to “allowed” frequencies. “Allowed” frequencies are intended to include frequencies that, in comparison to forbidden frequencies, may result in less fatigue, vibrations, and oscillations, for example of the tower. “Allowed” frequencies can be operational frequencies that are freely used in operation, or are more often used in operation than are forbidden frequencies. Herein, “damping” and “dampening” are used interchangeably. Herein, “locking” the damper can optionally be associated with increasing the stiffness of a component of the damper, such as the spring, dashpot, or combination of the two. Herein, a “damped wind turbine” is intended to mean a wind turbine with a damping system, which can damp motion in lateral and/or longitudinal directions. Herein, “frequency response” is intended to mean a frequency response of the tower, particularly in lateral and/or longitudinal directions of motion. Herein “movable mass,” “moving mass,” “second mass,” and/or “secondary mass” are used synonymously. Herein, the moving and/or movable mass can be a liquid. Herein, ranges can be continuous or discontinuous ranges.

As used herein, the term “blade” is intended to be representative of any device that provides a reactive force when in motion relative to a surrounding fluid. As used herein, the term “wind turbine” is intended to be representative of any device that generates rotational energy from wind energy, and more specifically, converts kinetic energy of wind into mechanical energy. As used herein, the term “wind generator” is intended to be representative of any wind turbine that generates electrical power from rotational energy generated from wind energy, and more specifically, converts mechanical energy converted from kinetic energy of wind to electrical power.

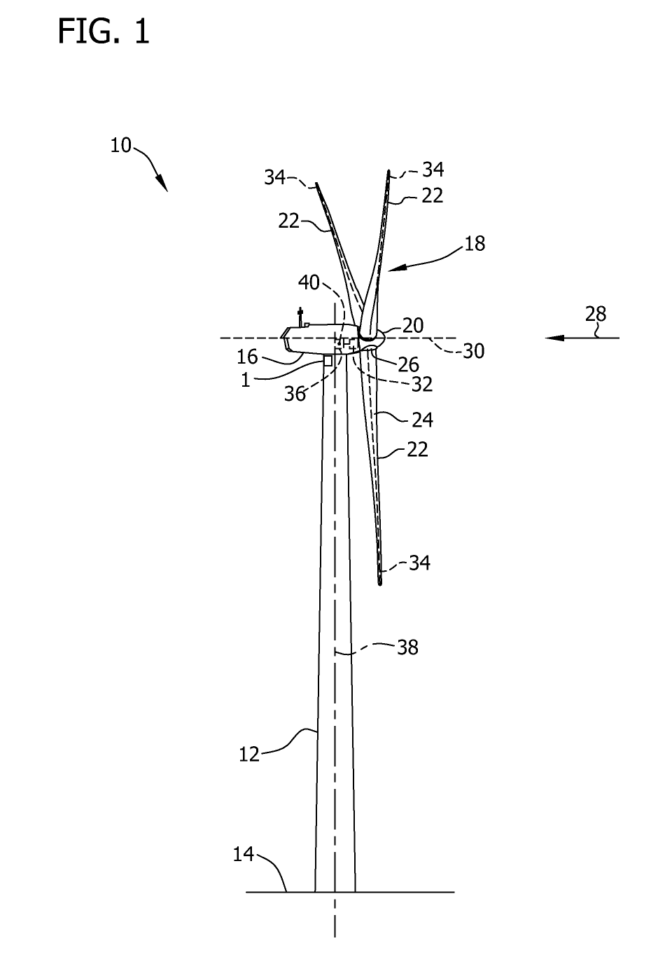

FIG. 1 is a perspective view of an exemplary wind turbine 10. In the exemplary embodiment, wind turbine 10 is a horizontal-axis wind turbine. Alternatively, wind turbine 10 may be a vertical-axis wind turbine. In the exemplary embodiment, wind turbine 10 includes a tower 12 that extends from a support system 14, a nacelle 16 mounted on tower 12, and a rotor 18 that is coupled to nacelle 16. Rotor 18 includes a rotatable hub 20 and at least one rotor blade 22 coupled to and extending outward from hub 20. In the exemplary embodiment, rotor 18 has three rotor blades 22. In an alternative embodiment, rotor 18 includes more or less than three rotor blades 22. In the exemplary embodiment, tower 12 is fabricated from tubular steel to define a cavity (not shown in FIG. 1) between support system 14 and nacelle 16. In an alternative embodiment, tower 12 is any suitable type of tower having any suitable height. A typical wind turbine is a soft-stiff type of wind turbine tower design.

Rotor blades 22 are spaced about hub 20 to facilitate rotating rotor 18 to enable kinetic energy to be transferred from the wind into usable mechanical energy, and subsequently, electrical energy. Rotor blades 22 are mated to hub 20 by coupling a blade root portion 24 to hub 20 at a plurality of load transfer regions 26. Load transfer regions 26 have a hub load transfer region and a blade load transfer region (both not shown in FIG. 1). Loads induced to rotor blades 22 are transferred to hub 20 via load transfer regions 26.

In one embodiment, rotor blades 22 have a length ranging from about 15 meters (m) to about 91 m. Alternatively, rotor blades 22 may have any suitable length that enables wind turbine 10 to function as described herein. For example, other non-limiting examples of blade lengths include 10 m or less, 20 m, 37 m, or a length that is greater than 91 m. As wind strikes rotor blades 22 from a direction 28, rotor 18 is rotated about an axis of rotation 30. As rotor blades 22 are rotated and subjected to centrifugal forces, rotor blades 22 are also subjected to various forces and moments. As such, rotor blades 22 may deflect and/or rotate from a neutral, or non-deflected, position to a deflected position.

Moreover, a pitch angle or blade pitch of rotor blades 22, i.e., an angle that determines a perspective of rotor blades 22 with respect to direction 28 of the wind, may be changed by a pitch adjustment system 32 to control the load and power generated by wind turbine 10 by adjusting an angular position of at least one rotor blade 22 relative to wind vectors. Pitch axes 34 for rotor blades 22 are shown. During operation of wind turbine 10, pitch adjustment system 32 may change a blade pitch of rotor blades 22 such that rotor blades 22 are moved to a feathered position, such that the perspective of at least one rotor blade 22 relative to wind vectors provides a minimal surface area of rotor blade 22 to be oriented towards the wind vectors, which facilitates reducing a rotational speed of rotor 18 and/or facilitates a stall of rotor 18.

In the exemplary embodiment, a blade pitch of each rotor blade 22 is controlled individually by a control system 36. Alternatively, the blade pitch for all rotor blades 22 may be controlled simultaneously by control system 36. Further, in the exemplary embodiment, as direction 28 changes, a yaw direction of nacelle 16 may be controlled about a yaw axis 38 to position rotor blades 22 with respect to direction 28.

In the exemplary embodiment, a damper 1, such as a damper for variably adjusting a frequency response of the tower and/or including a stiffness adjustment mechanism, is located near the top of the tower 12. Generally, the damper may be placed inside or outside the tower. The damper includes a movable mass.

In the exemplary embodiment, control system 36 is shown as being centralized within nacelle 16, however, control system 36 may be a distributed system throughout wind turbine 10, on support system 14, within a wind farm, and/or at a remote control center. Control system 36 includes a processor 40 configured to perform the methods and/or steps described herein. Further, many of the other components described herein include a processor. As used herein, the term “processor” is not limited to integrated circuits referred to in the art as a computer, but broadly refers to a controller, a microcontroller, a microcomputer, a programmable logic controller (PLC), an application specific integrated circuit, and other programmable circuits, and these terms are used interchangeably herein. It should be understood that a processor and/or a control system can also include memory, input channels, and/or output channels.

In the embodiments described herein, memory may include, without limitation, a computer-readable medium, such as a random access memory (RAM), and a computer-readable non-volatile medium, such as flash memory. Alternatively, a floppy disk, a compact disc-read only memory (CD-ROM), a magneto-optical disk (MOD), and/or a digital versatile disc (DVD) may also be used. Also, in the embodiments described herein, input channels include, without limitation, sensors and/or computer peripherals associated with an operator interface, such as a mouse and a keyboard. Further, in the exemplary embodiment, output channels may include, without limitation, a control device, an operator interface monitor and/or a display.

Processors described herein process information transmitted from a plurality of electrical and electronic devices that may include, without limitation, sensors, actuators, compressors, control systems, and/or monitoring devices. Such processors may be physically located in, for example, a control system, a sensor, a monitoring device, a desktop computer, a laptop computer, a programmable logic controller (PLC) cabinet, and/or a distributed control system (DCS) cabinet. RAM and storage devices store and transfer information and instructions to be executed by the processor(s). RAM and storage devices can also be used to store and provide temporary variables, static (i.e., non-changing) information and instructions, or other intermediate information to the processors during execution of instructions by the processor(s). Instructions that are executed may include, without limitation, wind turbine control system control commands. The execution of sequences of instructions is not limited to any specific combination of hardware circuitry and software instructions.

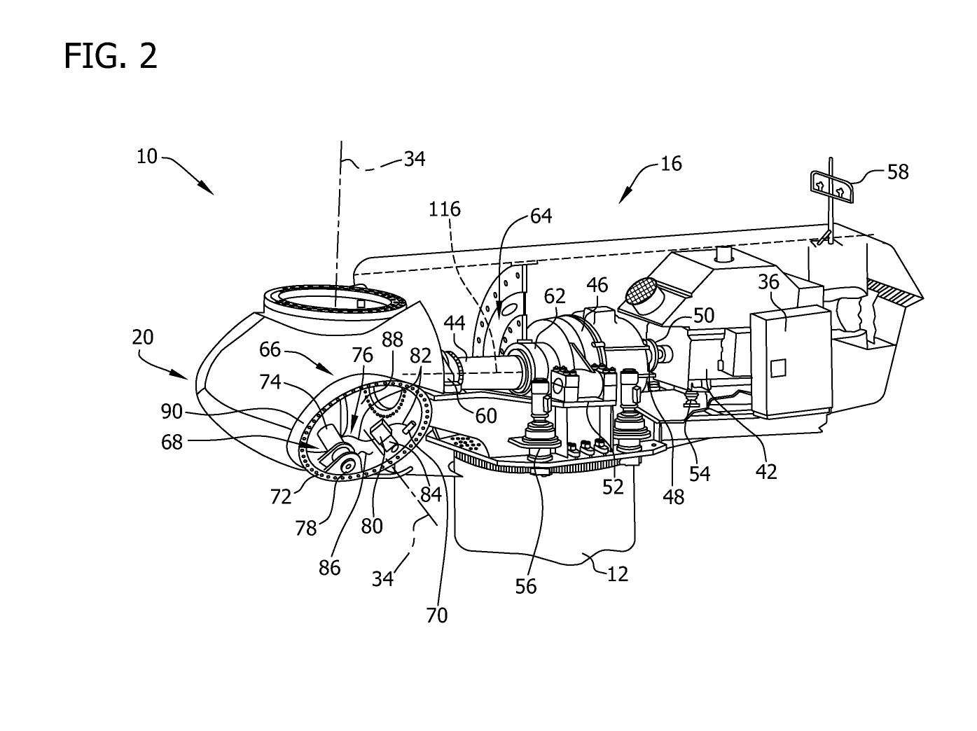

FIG. 2 is an enlarged sectional view of a portion of wind turbine 10. In the exemplary embodiment, wind turbine 10 includes nacelle 16 and hub 20 that is rotatably coupled to nacelle 16. More specifically, hub 20 is rotatably coupled to an electric generator 42 positioned within nacelle 16 by rotor shaft 44 (sometimes referred to as either a main shaft or a low speed shaft), a gearbox 46, a high speed shaft 48, and a coupling 50. In the exemplary embodiment, rotor shaft 44 is disposed coaxial to longitudinal axis 116. Rotation of rotor shaft 44 rotatably drives gearbox 46 that subsequently drives high speed shaft 48. High speed shaft 48 rotatably drives generator 42 with coupling 50 and rotation of high speed shaft 48 facilitates production of electrical power by generator 42. Gearbox 46 and generator 42 are supported by a support 52 and a support 54. In the exemplary embodiment, gearbox 46 utilizes a dual path geometry to drive high speed shaft 48. Alternatively, rotor shaft 44 is coupled directly to generator 42 with coupling 50.

Nacelle 16 also includes a yaw drive mechanism 56 that may be used to rotate nacelle 16 and hub 20 on yaw axis 38 (shown in FIG. 1) to control the perspective of rotor blades 22 with respect to direction 28 of the wind. Nacelle 16 also includes at least one meteorological mast 58 that includes a wind vane and anemometer (neither shown in FIG. 2). Mast 58 provides information to control system 36 that may include wind direction and/or wind speed. In the exemplary embodiment, nacelle 16 also includes a main forward support bearing 60 and a main aft support bearing 62.

Forward support bearing 60 and aft support bearing 62 facilitate radial support and alignment of rotor shaft 44. Forward support bearing 60 is coupled to rotor shaft 44 near hub 20. Aft support bearing 62 is positioned on rotor shaft 44 near gearbox 46 and/or generator 42. Alternatively, nacelle 16 includes any number of support bearings that enable wind turbine 10 to function as disclosed herein. Rotor shaft 44, generator 42, gearbox 46, high speed shaft 48, coupling 50, and any associated fastening, support, and/or securing device including, but not limited to, support 52 and/or support 54, and forward support bearing 60 and aft support bearing 62, are sometimes referred to as a drive train 64.

In the exemplary embodiment, hub 20 includes a pitch assembly 66. Pitch assembly 66 includes one or more pitch drive systems 68 and at least one sensor 70. Each pitch drive system 68 is coupled to a respective rotor blade 22 (shown in FIG. 1) for modulating the blade pitch of associated rotor blade 22 along pitch axis 34. Only one of three pitch drive systems 68 is shown in FIG. 2.

In the exemplary embodiment, pitch assembly 66 includes at least one pitch bearing 72 coupled to hub 20 and to respective rotor blade 22 (shown in FIG. 1) for rotating respective rotor blade 22 about pitch axis 34. Pitch drive system 68 includes a pitch drive motor 74, pitch drive gearbox 76, and pitch drive pinion 78. Pitch drive motor 74 is coupled to pitch drive gearbox 76 such that pitch drive motor 74 imparts mechanical force to pitch drive gearbox 76. Pitch drive gearbox 76 is coupled to pitch drive pinion 78 such that pitch drive pinion 78 is rotated by pitch drive gearbox 76. Pitch hearing 72 is coupled to pitch drive pinion 78 such that the rotation of pitch drive pinion 78 causes rotation of pitch bearing 72. More specifically, in the exemplary embodiment, pitch drive pinion 78 is coupled to pitch bearing 72 such that rotation of pitch drive gearbox 76 rotates pitch bearing 72 and rotor blade 22 about pitch axis 34 to change the blade pitch of blade 22.

Pitch drive system 68 is coupled to control system 36 for adjusting the blade pitch of rotor blade 22 upon receipt of one or more signals from control system 36. In the exemplary embodiment, pitch drive motor 74 is any suitable motor driven by electrical power and/or a hydraulic system that enables pitch assembly 66 to function as described herein. Alternatively, pitch assembly 66 may include any suitable structure, configuration, arrangement, and/or components such as, but not limited to, hydraulic cylinders, springs, and/or servo-mechanisms. Moreover, pitch assembly 66 may be driven by any suitable means such as, but not limited to, hydraulic fluid, and/or mechanical power, such as, but not limited to, induced spring forces and/or electromagnetic forces. In certain embodiments, pitch drive motor 74 is driven by energy extracted from a rotational inertia of hub 20 and/or a stored energy source (not shown) that supplies energy to components of wind turbine 10.

Pitch assembly 66 also includes one or more overspeed control systems 80 for controlling pitch drive system 68 during rotor overspeed. In the exemplary embodiment, pitch assembly 66 includes at least one overspeed control system 80 communicatively coupled to respective pitch drive system 68 for controlling pitch drive system 68 independently of control system 36. In one embodiment, pitch assembly 66 includes a plurality of overspeed control systems 80 that are each communicatively coupled to respective pitch drive system 68 to operate respective pitch drive system 68 independently of control system 36. Overspeed control system 80 is also communicatively coupled to sensor 70. In the exemplary embodiment, overspeed control system 80 is coupled to pitch drive system 68 and to sensor 70 with a plurality of cables 82. Alternatively, overspeed control system 80 is communicatively coupled to pitch drive system 68 and to sensor 70 using any suitable wired and/or wireless communications device. During normal operation of wind turbine 10, control system 36 controls pitch drive system 68 to adjust a pitch of rotor blade 22. In one embodiment, when rotor 18 operates at rotor overspeed, overspeed control system 80 overrides control system 36, such that control system 36 no longer controls pitch drive system 68 and overspeed control system 80 controls pitch drive system 68 to move rotor blade 22 to a feathered position to slow a rotation of rotor 18.

A power generator 84 is coupled to sensor 70, overspeed control system 80, and pitch drive system 68 to provide a source of power to pitch assembly 66. In the exemplary embodiment, power generator 84 provides a continuing source of power to pitch assembly 66 during operation of wind turbine 10. In an alternative embodiment, power generator 84 provides power to pitch assembly 66 during an electrical power loss event of wind turbine 10. The electrical power loss event may include power grid loss, malfunctioning of the turbine electrical system, and/or failure of the wind turbine control system 36. During the electrical power loss event, power generator 84 operates to provide electrical power to pitch assembly 66 such that pitch assembly 66 can operate during the electrical power loss event.

In the exemplary embodiment, pitch drive system 68, sensor 70, overspeed control system 80, cables 82, and power generator 84 are each positioned in a cavity 86 defined by an inner surface 88 of hub 20. In a particular embodiment, pitch drive system 68, sensor 70, overspeed control system 80, cables 82, and/or power generator 84 are coupled, directly or indirectly, to inner surface 88. In an alternative embodiment, pitch drive system 68, sensor 70, overspeed control system 80, cables 82, and power generator 84 are positioned with respect to an outer surface 90 of hub 20 and may be coupled, directly or indirectly, to outer surface 90.

In the exemplary embodiment, controller is a real-time controller that includes any suitable processor-based or microprocessor-based system, such as a computer system, that includes microcontrollers, reduced instruction set circuits (RISC), application-specific integrated circuits (ASICs), logic circuits, and/or any other circuit or processor that is capable of executing the functions described herein. In one embodiment, controller may be a microprocessor that includes read-only memory (ROM) and/or random access memory (RAM), such as, for example, a 32 bit microcomputer with 2 Mbit ROM, and 64 Kbit RAM. As used herein, the term “real-time” refers to outcomes occurring a substantially short period of time after a change in the inputs affect the outcome, with the time period being a design parameter that may be selected based on the importance of the outcome and/or the capability of the system processing the inputs to generate the outcome.

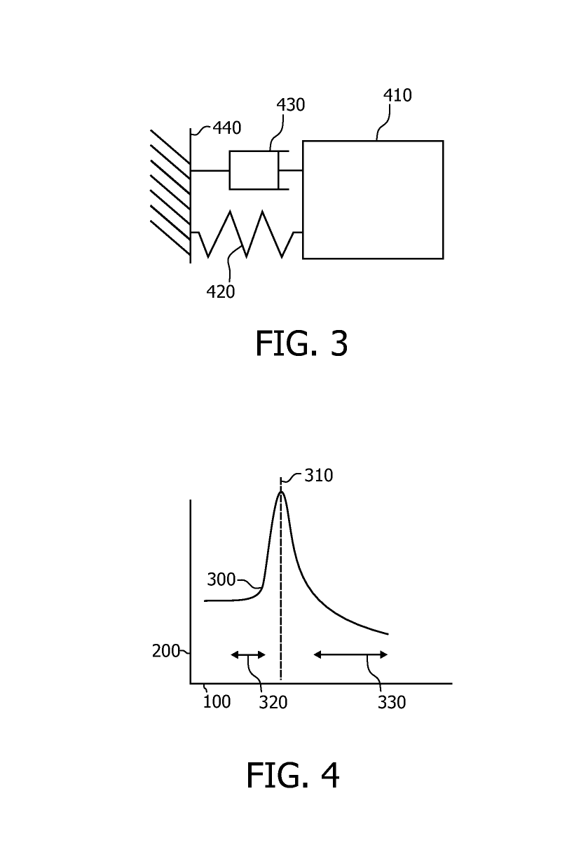

FIG. 3 is an illustrative model of a wind turbine, a mass 410 coupled to a spring 420 and a dashpot 430 which can be a virtual dashpot which models the natural dampening of oscillatory motion of the wind turbine; the spring 420 and dashpot 430 also coupled to a base 440 which can be a surface or the ground. The mass 410 undergoes oscillations at a natural frequency or resonance 310 (FIG. 4), and the dashpot 430 can damp the oscillations. Typically, the embodiments described herein relate to oscillations of the tower of the wind turbine.

For example, FIG. 3 can model the dynamic bending behavior of the wind turbine tower as a first order system: the spring 420 represents the equivalent stiffness of the tower; the dashpot 430 represents the damping of the tower such as structural and/or aerodynamic damping); the mass 410 represents the equivalent mass of the tower, nacelle, and other components within or attached thereto. For example, the mass is heavily oscillating when excited at the natural frequency, and the dashpot damps the amplitude of the oscillation at a rate that depends on the damping characteristics.

FIG. 4 illustrates a frequency response of a wind turbine. The response is plotted in the vertical axis 200 versus frequency, for example a driving frequency such as at least one of the 1 P or 3 P frequencies, on the horizontal axis 100. Alternatively or additionally, the vertical axis 200 can represent the amplitude of motion, plotted versus excitation frequency on the horizontal axis 100. The response curve, or first response 300, shows a resonance peak 310. For example, a wind turbine, illustrated by a model such as that of FIG. 3 can exhibit a resonance peak such as the resonance peak 310 of the first response 300 shown in FIG. 4. Operation of the wind turbine at an operational frequency near the resonance can lead to exciting the resonance 310 of the wind turbine, increasing mechanical fatigue and risk of damage to the wind turbine. The resonance 310 can be for example the first or second bending mode, and/or lateral motion of the tower. Operating the wind turbine at frequencies away from the resonance, for example in the low range 320 and/or the high range 330, do not as efficiently excite the resonance 310 and show less response in comparison to operating near the resonance 310. For example, a wind turbine can be operated at two operational frequencies simultaneously, both away from the resonance 310: a rotor frequency within the low range 320, and a blade frequency, which can be three times the rotor frequency in the case of wind turbines with three blades per rotor, within the high range 330.

FIG. 4 illustrates a case of a wind turbine with a resonance 310 within a forbidden frequency range which can be avoided by allowing the wind turbine to be operated with operational frequencies in the low range 320 and/or high range 330, excluding a forbidden range near the resonance 310. It is desirable to have a large range of allowed operational frequencies that do not increase mechanical fatigue and the risk of damage to the wind turbine, such as those frequencies that have a high response, are near a resonance, and/or are inefficiently damped. A large range of possible operational frequencies can increase the energy production of the wind turbine, because constraints, such as ranges of forbidden operational frequencies that would increase risks of mechanical fatigue due to resonances, are relaxed.

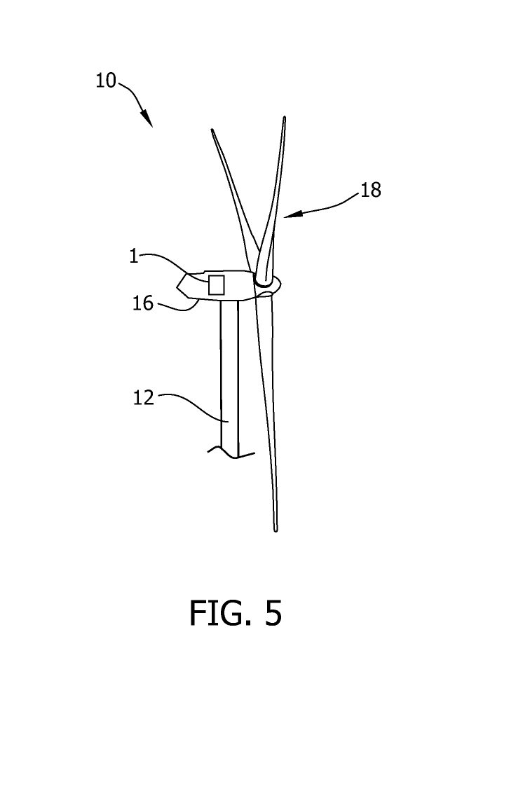

FIG. 5 is an exemplary wind turbine 10, according to an embodiment which can be combined with other embodiments described herein. The exemplary wind turbine 10 includes a rotor 18 arranged at a nacelle 16; the nacelle 16 supported by a tower 12; and a damper 1 which includes a movable mass. In an embodiment, the damper is adapted for variably adjusting a frequency response of the wind turbine. Alternatively or additionally, the damper 1 includes a stiffness adjustment mechanism, for example a locking mechanism. In an embodiment which may be combined with other embodiments, when the damper 1 is locked, the locking mechanism immobilizes the movable mass of the damper.

The damper 1 can be placed for example in the nacelle, attached to the nacelle, or placed in the tower or attached to the tower. For example, the damper can be placed in the upper portion of the tower, such as near the top of the tower. Typically, the damper 1 is more effective when it is placed as high as possible, which is typically near the top of the tower. For example, the damper is placed within a few percent of distance of the height of the tower from the top of the tower, for example more than 80% of the way to the top of the tower, or more than 90%, or more than 95%. The damper can be a passive, active, or semiactive tuned damper.

Optionally an additional damper can be located in the nacelle or near the top of the tower, and the additional damper can be oriented at 90 degrees from the first damper, for example to damp two dimensional oscillations (e.g. in two perpendicular directions), or even more. When two dampers are used, for example for damping motion in two perpendicular directions, they can be placed at equal height, for example near the top of the tower.

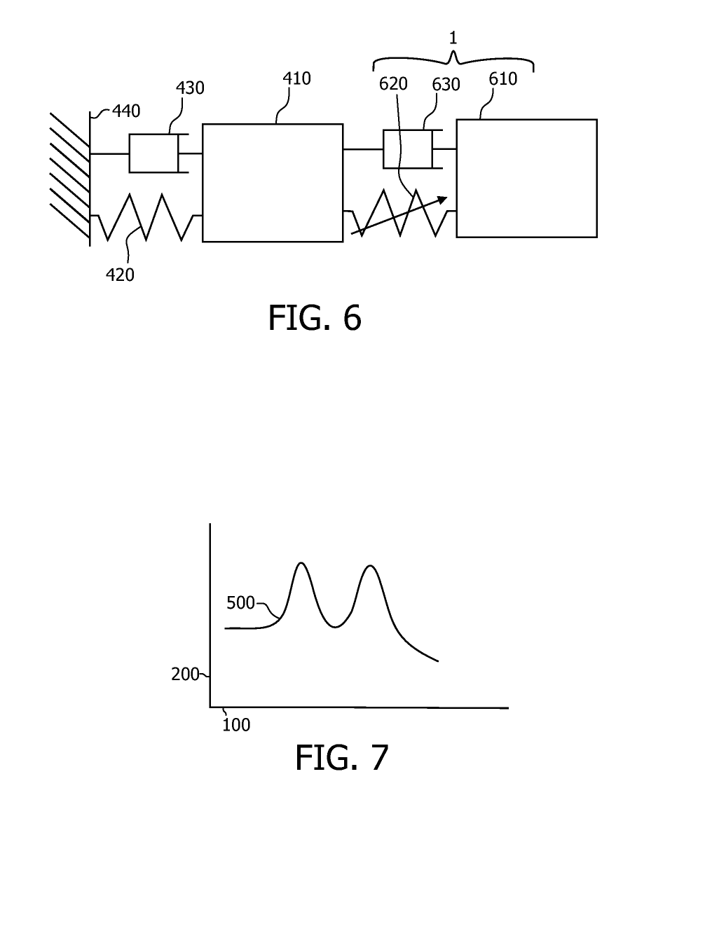

FIG. 6 is an illustrative model of a damped wind turbine, according to embodiments described herein, which may be combined with other embodiments. In addition to the wind turbine modeled as a mass 410, spring 420, and dashpot 430 on a base 440; the wind turbine also includes a damper 1 including a second mass 610 (i.e. a movable mass), a second spring 620, and second optional dashpot 630. Optionally, and not limited to the present embodiment, the second spring 620 has a variable stiffness, and the damper is an adjustable tuned mass damper. The second mass 610 is coupled to the mass 410 through the second spring 620 and second optional dashpot 630. In other words, the movable mass is coupled to the mass of the wind turbine. Typically, the mass of the second mass 610 is on the order of 5 to 10% of the equivalent moving mass of the tower, nacelle, and rotor and components therein, and are sufficient to damp the tower motion, having a significant impact on the lateral and/or longitudinal tower motion. The damper can be tuned to a natural frequency of the tower, for example the damper 1 has the same or nearly the same natural frequency as the first lateral or longitudinal bending frequency of the tower, which increases the effectiveness of the damping.

In an embodiment which may be combined with other embodiments, the damper 1 (which includes the second mass 610, the second spring 620, and the second optional dashpot 630) is adjustable, particularly to adjust the frequency response of the wind turbine.

FIG. 7 is an illustration of a damped frequency response of a wind turbine tower including a passive tuned mass damper. The second response 500, or frequency response of the damped wind turbine tower, is plotted on the vertical axis 200 versus frequency on the horizontal axis 100, and shows two peaks rather than one (the first response 300, i.e. the frequency response of an undamped wind turbine tower, and/or one without a passive tuned mass damper is plotted in FIG. 4). The passive tuned mass damper can reduce the response at a specific frequency, such as the resonance of the wind turbine without the tuned mass damper.

For example, FIG. 6 illustrates a model of a wind turbine with a damper 1, and a second response 500, i.e. frequency response, illustrated in FIG. 7. The maximum response of the damped wind turbine, i.e. the maximum of the second response 500, can be less than the maximum response of the first response 300 (i.e. at the resonance 310) of a less damped, more freely oscillating, and/or undamped wind turbine tower. Typical of wind turbines with tuned mass dampers is that two natural frequencies, one below and one above the original tower natural frequency (without the tuned mass damper) are present. Compared to a one degree of freedom system, such as without a tuned mass damper; the frequency response at the two natural frequencies of the two degrees of freedom system, such as with a tuned mass damper, may be higher. Embodiments described herein may take away or lessen these frequency response peaks.

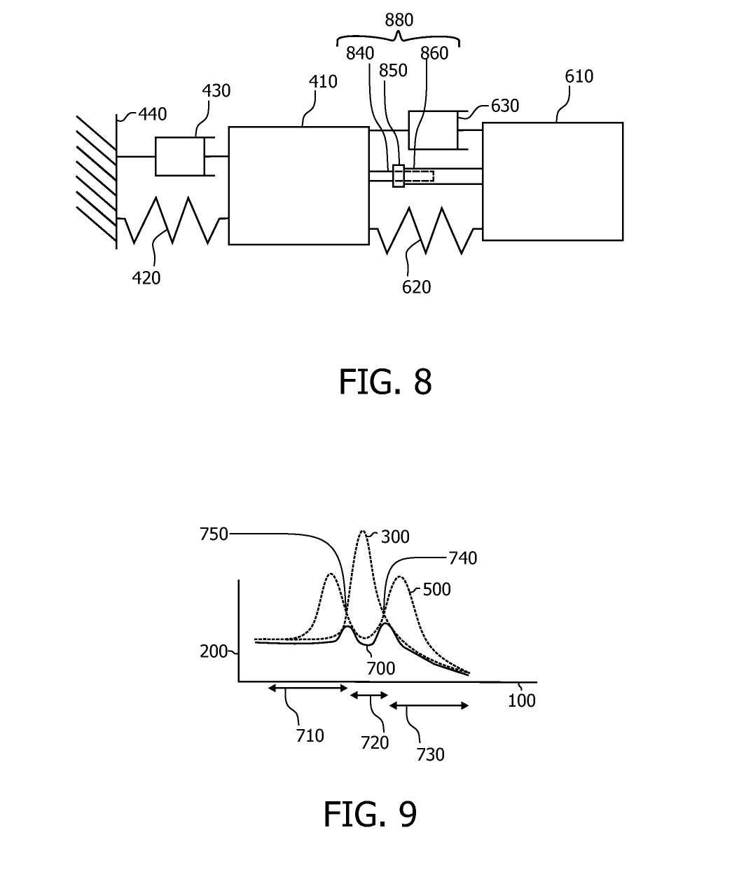

FIG. 8 is an illustrative model of a damped wind turbine. In an embodiment, the damped wind turbine includes a stiffness adjustment mechanism 880. The damper, which can be combined with any other embodiment, and which includes the second mass 610 (movable mass), second spring 620, optional second dashpot 630 can variably adjust the frequency response of the wind turbine in correspondence with the variation of stiffness. In an embodiment, the control system selects a frequency response of the wind turbine and/or is communicatively coupled to the damper and/or the stiffness adjustment mechanism 880. By adjusting the damper, the controller influences or selects the frequency response of the wind turbine, such as selecting the first response 300 which corresponds to a high level of stiffness or the second response 500 which corresponds to a low level of stiffness. In an embodiment, and not limited to the illustrative model of FIG. 8, the stiffness adjustment mechanism 880 includes a locking mechanism 850. Further, the stiffness adjustment mechanism 880 can include a sleeve 860, and rod 840. Alternatively or additionally, the locking mechanism 850 can be part of the spring 620 and/or dashpot 630, a feature which is generally combinable with other embodiments. In an embodiment, which may be combined with other embodiments described herein, the locking mechanism 850 is a hydraulic actuator with a piston for restraining and/or blocking the motion of the second mass 610 (movable mass).

In an embodiment, the stiffness adjustment mechanism is a component of the damper. Alternatively or additionally, the stiffness adjustment mechanism is a component of the wind turbine. Generally the stiffness adjustment mechanism restrains and/or blocks the motion of the movable mass 610. In an embodiment, which may be combined with other embodiments, the damper can be locked by the locking mechanism to increase stiffness, and unlocked to decrease stiffness.

FIG. 9 is an illustration of frequency response curves, according to various models of wind turbines. Responses are plotted in a vertical axis 200 versus frequency on the horizontal axis 100. First response 300 and second response 500 are overlaid, showing how the damping of the wind turbine can split the resonance 300 of a more freely oscillating and/or undamped wind turbine (particularly oscillations of the tower of the wind turbine). The frequencies have a low range 710, middle range 720 which is near the peak of the first response 300 of the more freely oscillating wind turbine, and high range 730. For example, operational frequencies that coincide with or are near any maximum of the responses 300, 500 can be avoided by adjusting the frequency response of the tower, particularly by switching from one of the response curves 300, 500 to the other, in other words selecting the frequency response with, the lower response 300, 500 at the operating frequency.

An advantage of embodiments disclosed herein is that wind turbines including a damper that can variably adjust the frequency response of the wind turbine, for example effectively providing the third frequency response 700, can be operated throughout a larger range of frequencies, especially in comparison to a wind turbine with a response such as the first response 300 or a wind turbine with the second response 500. For example, a substantial fraction, most, or all of the low 710, middle 720 and high 730 frequency ranges are allowed for operation of a wind turbine with an adjustable damper, because operation of the wind turbine at frequencies with high responses which increase the risk of damage due to fatigue is avoided. The illustrated third frequency response 700 can be a combination of the first response 300 and second response 500.

In an embodiment, the damper 1 of a wind turbine 10 is locked by the locking mechanism 850 to increase stiffness and/or unlocked to decrease stiffness. For example, the wind turbine is operating at an operational frequency within the low range 710, according to the first response 300, and the damper is locked. As wind speed increases, the operational frequency increases, and to avoid operating the wind turbine near the maximum of the first resonance 300, the damper is unlocked so as to operate the wind turbine according to the second response 500 while the operational frequency is within the middle range 720. As the operational frequency possibly further increases, the damper can be again locked as the operational frequency increases to the high range 730.

For example, the damper is unlocked when the (increasing) operational frequency reaches the first intersection 750 of the first and second responses 300, 500. For example, the damper is locked when the (increasing) operational frequency reaches the second intersection 740 of the first and second responses 300, 500. For the opposite case, of decreasing operational frequency (e.g. going from the high range 730 through the middle and low ranges 720, 710) the unlocking and locking of the damper is performed in a similar manner to affect a more damped response. Typically, the selection of a response curve (i.e. switching between unlocked and locked) is at intersections of the frequency response curves, occurring so as to affect a lower response.

In an embodiment, the damper is locked by the locking mechanism 850 when the wind turbine is operated within a first range of operational frequencies (e.g. the first range includes the low 710 and high 730 ranges); and the damper may be unlocked by the locking mechanism when the wind turbine is operated within a second range of operational frequencies (e.g. the middle range 720 which is near the resonance of the wind turbine when the damper is locked).

According to an embodiment, which may be combined with other embodiments, the liquid is a movable mass. According to another combinable embodiment, the damper does not include a spring, rather utilizing gravitational force on the movable mass rather than the force of a spring.

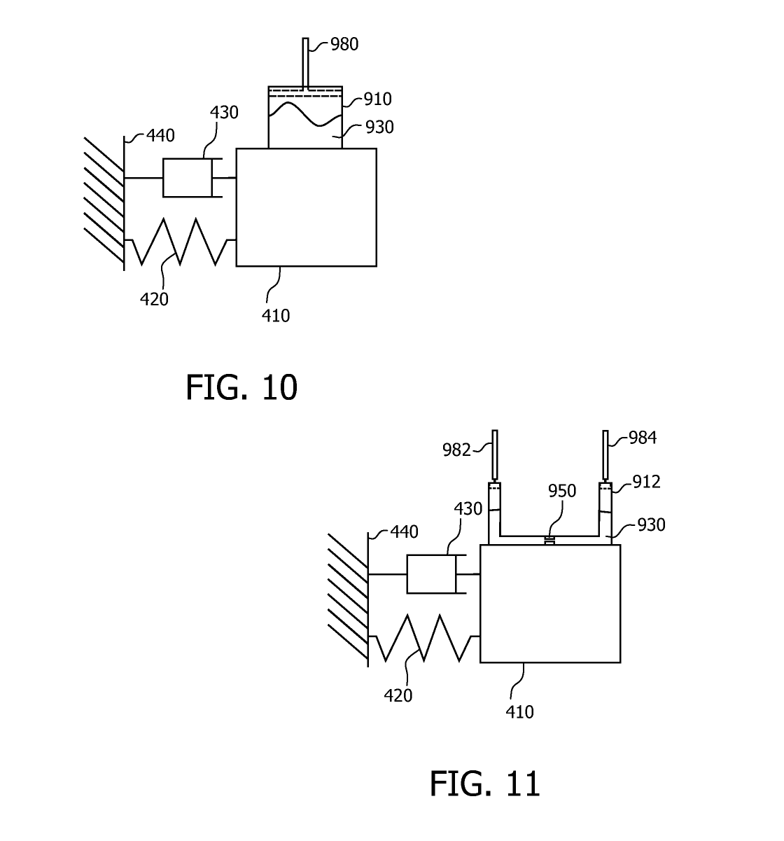

FIG. 10 is an illustration of a liquid damped wind turbine, according to embodiments described herein. The damper includes a container 910 partially filled with liquid 930 such as seawater, and a plunger 980 which can be a stiffness adjustment mechanism and/or locking mechanism. Oscillations of the wind turbine, modeled as a mass 410, spring 420, and dashpot 430, are damped by the damper 910, 930, 980. The plunger 980 increases the stiffness of the damper, adjusts the frequency response of the wind turbine, and/or locks the damper by insertion into the container 910 which can restrain and/or block motion of the liquid 930. The plunger can be communicatively coupled to the control system.

FIG. 11 is an illustration of a liquid damped wind turbine, according to embodiments described herein. The damper includes a U-shaped container 912 with an optional orifice 950 for adjusting the rate of flow of a liquid 930 within the U-shaped container 912. A first plunger 982 and optional second plunger 984 operate by reversible insertion into the U-shaped container 912 to increase the stiffness of the damper, adjust the frequency response of the damped wind turbine, and/or lock the damper. The first and second plunger can each individually or in combination be a stiffness adjustment mechanism and/or locking mechanism. Alternatively or additionally, the stiffness of the damper and/or adjustment of the frequency response of the damped wind turbine can be done by adjusting the orifice 950, such as its width.

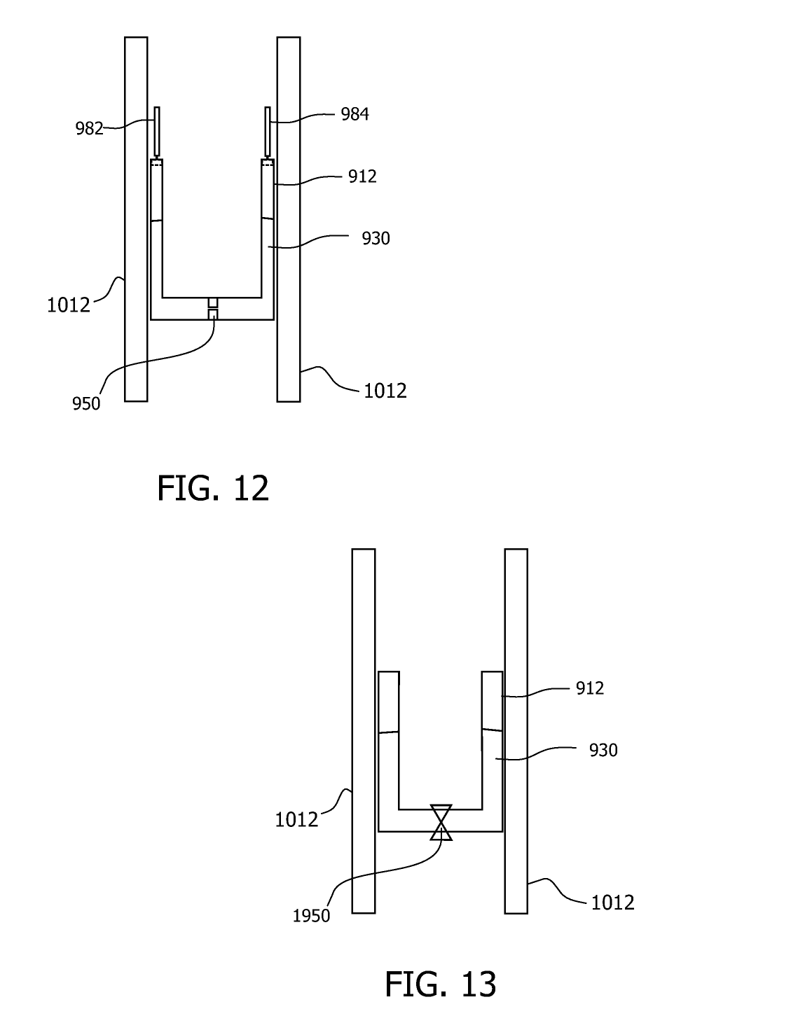

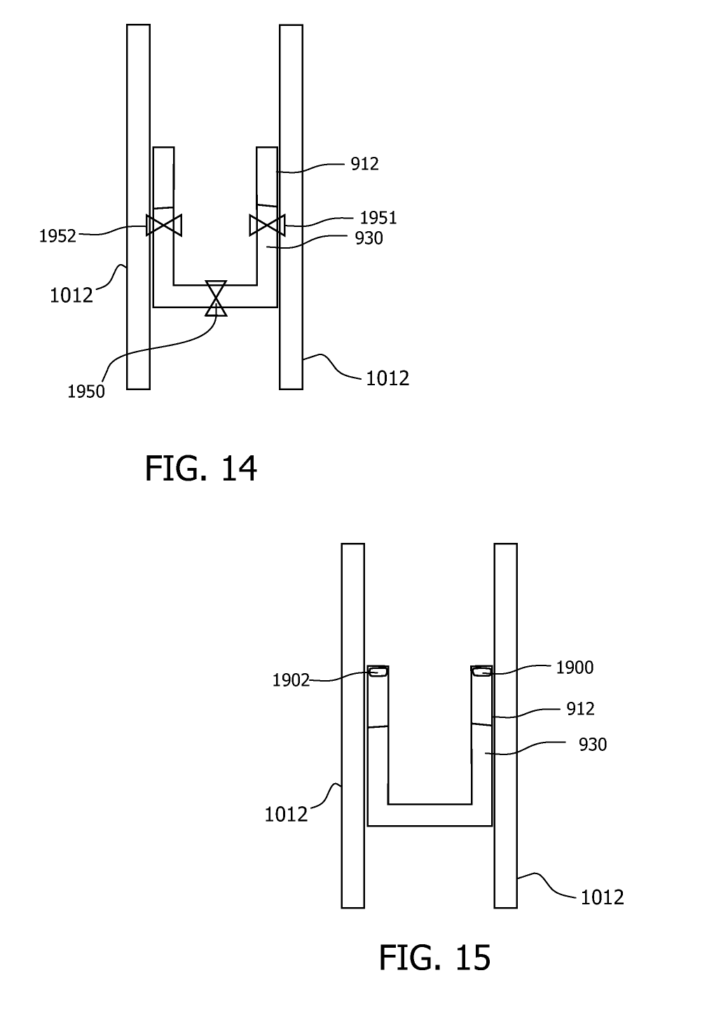

FIG. 12 is a cross-section of a portion of a wind turbine including a damper, according to embodiments described herein, which may be combined with other embodiments. Depicted are: the wall of the tower 1012; first and second plungers, 982 and 984; the U shaped liquid container 912; liquid 930; and optional orifice 950. FIG. 12 depicts the arrangement of the U shaped container 912 within the tower. FIG. 13 similarly depicts a cross-section of a portion of a wind turbine including a U shaped liquid container 912, and also including a locking valve 1950 which may be an activable check valve, activable spring loaded valve, adjustable throttle valve or the like. In an embodiment, the locking valve 1950 is closed and/or impedes the flow of the liquid to lock the damper, and the locking valve 1950 is opened to unlock the damper. FIG. 14 similarly depicts a cross-section of a portion of a wind turbine including a U shaped liquid container 912, and three locking valves 1950, 1951, and 1952. Thus, more than one locking valve is contemplated, such as 2, 4, 6, 8, 10 and all integers between, which provide the advantage of more completely impeding the movement of the liquid 930 within the U shaped liquid container 912.

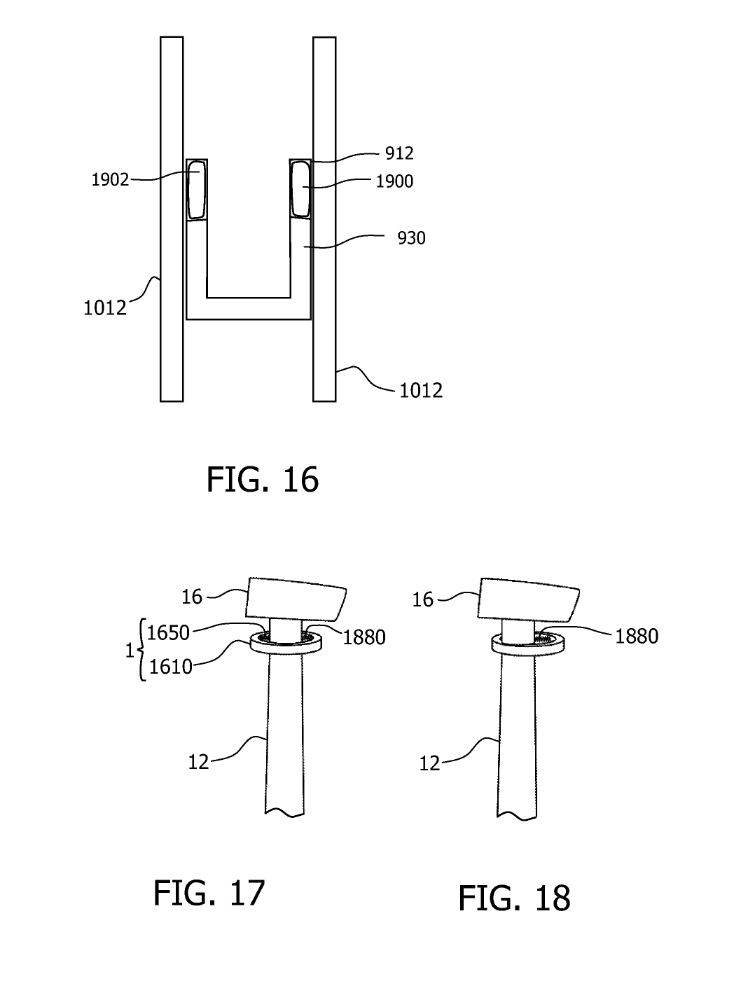

FIG. 15 is a cross-section of a portion of a wind turbine including a damper, according to embodiments described herein. FIG. 15 depicts the wall of the tower 1012, the U shaped liquid container 912 containing the liquid 930, and two inflatable stoppers 1900, 1902. FIG. 15 depicts an unlocked configuration in which the inflatable stoppers 1900, 1902 are deflated. FIG. 16 similarly depicts the wind turbine including a damper, in the locked configuration, with the inflatable stoppers 1900, 1902 inflated so as to restrain and/or block the motion of the liquid 930 within the U shaped liquid container 912. Typically, a compressor can be used to inflate and deflate the inflatable stoppers 1900, 1902.

FIG. 17 is a portion of a wind turbine with a damper which is adapted for variably adjusting a frequency response of the wind turbine and/or includes a stiffness adjustment mechanism, according to embodiments described herein, which may be combined with other embodiments. The damper includes a ring shaped mass 1610 which is movable, disposed near the top of the tower 12, around the tower, such as near the nacelle 16. Alternatively or additionally, the ring shaped mass 1610 can be placed within the tower. The ring shaped mass 1610 is coupled to the tower through a spring assembly 1650, which optionally includes a dashpot. The ring shaped mass 1610 and spring assembly 1650 make up the damper 1, and the ring shaped mass 1610 is movable. More than one spring assembly 1650 are contemplated, such as a pair offset by approximately 180 degrees which may damp mainly longitudinal or lateral motion, or four offset by approximately 90 degrees which may more effectively damp both longitudinal and lateral motion. Furthermore, three spring assembly 1650 offset by approximately 120 degrees are contemplated. A locking mechanism and/or stiffness adjustment mechanism 1880 is variably coupled to the ring shaped mass 1610 and tower 12, which is shown at 180 degrees from the damper 1. Other geometries are contemplated, such as approximately parallel. More than one stiffness adjustment mechanism 1880 is contemplated, such as 2, 3 or 4.

Generally, the stiffness adjustment mechanism(s) may be a component of the damper, placed on an opposite side(s) of the tower from the damper(s), next to the damper(s), and/or symmetrically disposed around or within the tower. FIG. 18 also shows the portion of the wind turbine, similarly to FIG. 17, including the nacelle 16 and tower 12. In FIG. 18, the ring shaped mass 1610 is asymmetrically disposed about the tower 12 due to the activation (e.g. extension) of the stiffness adjustment mechanism 1880 which may be a locking mechanism, as in an exemplary locked configuration.

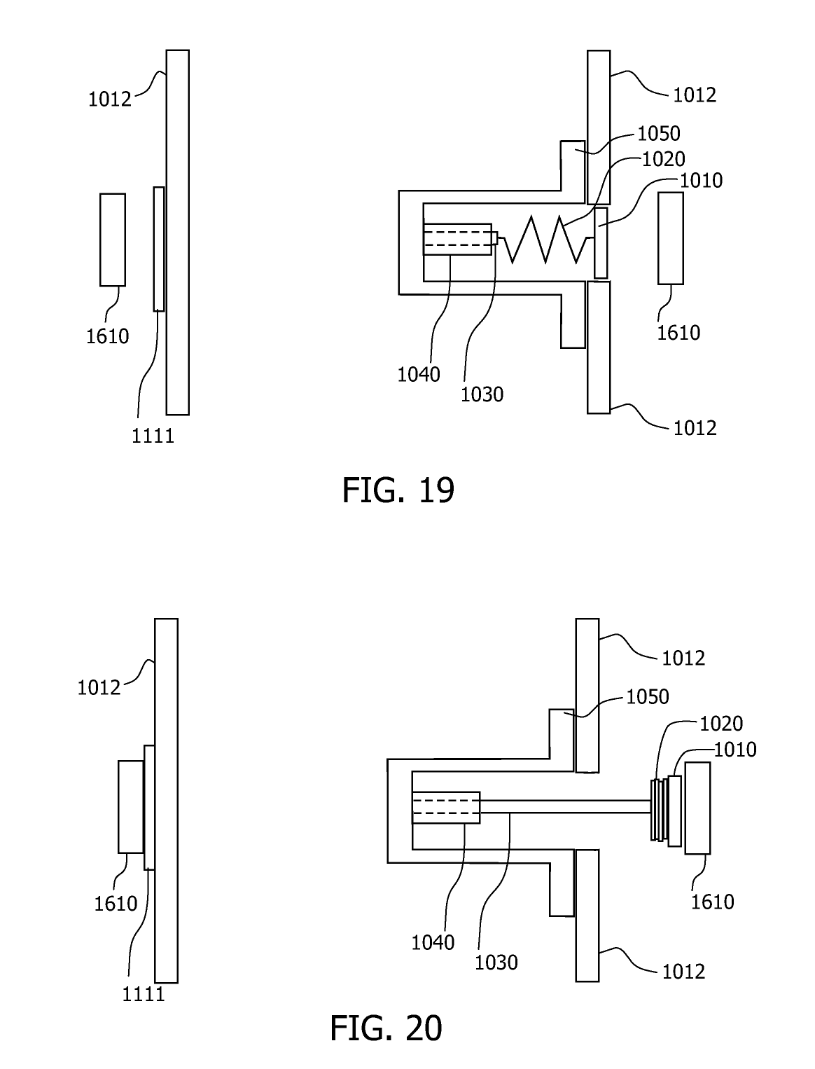

FIG. 19 is a cross-section of a portion of a wind turbine including a damper (not shown), according to embodiments described herein, which may be combined with other embodiments. Depicted are: walls of the tower 1012 extending in the vertical direction; the ring shaped mass 1610; a bracket 1050 connected to an wall of the tower, the bracket 1050 housing an actuator which is a sleeve 1040 (i.e. a cylinder) for a piston 1030 which can be a telescoping piston; a locking spring 1020 which is attached to the piston 1030 and a plate 1010. In an embodiment, the locking mechanism includes the locking spring 1020 and the piston 1030. The piston is generally a hydraulically activated piston, or a pneumatic piston. FIG. 19 depicts an embodiment of an unlocked damper, whereas FIG. 20 depicts an embodiment of the damper in a locked configuration, with the piston 1030 extended so that the locking spring 1020 is compressed, and the plate 1010 restrains the ring shaped mass 1610. More than one locking mechanism is contemplated, for example two, three, or four locking mechanisms, arranged at 180 degrees, 120 degrees, and 90 degrees, respectively. Additionally, two locking mechanisms arranged at 90 degrees are also contemplated. An advantage of multiple locking mechanisms is the ability to lock and unlock the damper's motion in more than one direction, particularly longitudinal and lateral motion. FIGS. 19 and 20 also show a cushion 1111, which resides between the wall of the tower 1012 and the ring shaped mass 1610, opposite to the locking mechanism, i.e. opposite the bracket 1050.

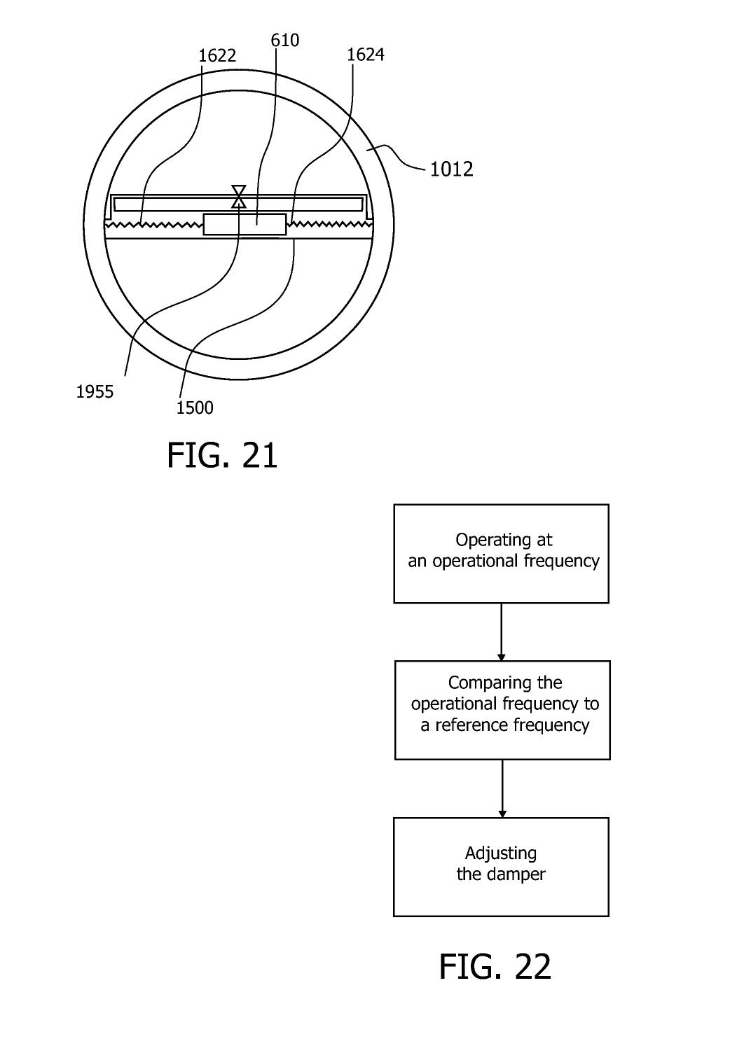

FIG. 21 is a horizontal cross-section of a portion of a wind turbine including a damper, according to embodiments described herein, which may be combined with other embodiments. Depicted are: the wall of the tower 1012, the second mass 610 (the movable mass); a pair of secondary springs 1622 and 1624, each attached to the second mass 610 and with opposite ends directed toward opposite sides of the inner wall of the tower; a chamber 1500 containing fluid; and a fluid valve 1955 to variably restrain and/or block the flow of the fluid. The movement of the second mass 610 compresses one of the pair of secondary springs 1622 while stretching the other 1624 (and vice versa for oppositely directed motion of the movable mass), and simultaneously induces flow of the fluid around the chamber. The damper is locked by closing the fluid valve 1955 and/or restricting the flow of fluid through the fluid valve by adjusting the fluid valve 1955. The fluid can be oil or water, including solutions of water such as salt water. The fluid is typically an incompressible fluid.

FIG. 22 is a schematic of a method of operating a wind turbine, according to embodiments described herein, which may be combined with other embodiments. A wind turbine is operated at an operational frequency, which can be a rotor rotational frequency (e.g. 1 P frequency) and/or a blade passing frequency (e.g. 3 P frequency). Typically signals from sensors or components of the wind turbine that are communicatively coupled to the controller are passed to the controller, such as signals related to the rotational frequency of the rotor and optionally signals indicating the amplitude of motion for example oscillatory motion of the tower. In an embodiment, the operational frequency is compared to a reference frequency to form a comparison. For example, the reference frequency is: the peak resonance frequency of the wind turbine with a locked and/or stiffened damper, the natural tower frequency, a frequency with a response above the baseline at an edge of a peak, and/or a frequency at an intersection 750 and/or 740 of response curves of a locked and unlocked damper (FIG. 9). The comparison is used to determine whether to adjust the stiffness of the damper, for example to lock or unlock it and/or to adjust the response of the wind turbine.

For example, the operational frequency of a wind turbine with a locked damper is compared to a reference frequency such as an intersection of two response curves, e.g. the first intersection 750 (FIG. 9) of two response curves corresponding to a locked and unlocked damper. In an embodiment, a comparison is made which is a Boolean variable that corresponds to whether or not the current operational frequency is greater than the frequency at the first intersection 750. In the case that the comparison is false, then the damper is, for example, unlocked and/or adjusted for decreased stiffness.

In another example, two reference frequencies are utilized, e.g. the first and second intersections 750, 740 (FIG. 9) of two response curves. For example, when the operational frequency lies between the first and second intersections, the damper is locked (or adjusted for increased stiffness), otherwise it is unlocked (or adjusted for decreased stiffness). For example, the comparison is represented by two Boolean variables that correspond to whether the operational frequency is greater than the first intersection 750, and whether the operational is greater than the second intersection 740; and the damper is unlocked if both Boolean variables are equal, and locked if the Boolean variables are not equal. Alternatively or additionally, the damper is adjusted for increased stiffness when the Boolean variables are not equal, and is otherwise adjusted for decreased stiffness.

In another example, the operational frequency is compared to a natural frequency of the tower when the damper is locked. If the operational frequency is determined to be near the natural frequency of the tower in the locked condition (i.e. within the resonance peak, given its width), the damper is adjusted to be unlocked and/or its stiffness reduced. For example, the natural frequency is a frequency which has a response that is approximately 5%, 10%, 15%, 20%, 25% or 33% greater than the baseline of the frequency response of the wind turbine with, a locked damper. Alternatively or additionally, near the natural frequency can be within a range of frequencies around the resonance peak of the wind turbine with a locked damper, such as the envelope of frequencies that make up the resonance, having a width, which rises above the response baseline.

In an embodiment, which may be combined with other embodiments described herein, the controller is adapted to select the frequency response of the wind turbine for adjusting the damper. In yet another combinable embodiment, the variable stiffness of the damper is adjusted in correspondence with the variable adjustment of the frequency response of the wind turbine. In yet another combinable embodiment, the locking mechanism immobilizes the movable mass by activation of a piston, a valve, an inflatable stopper, or combinations thereof.

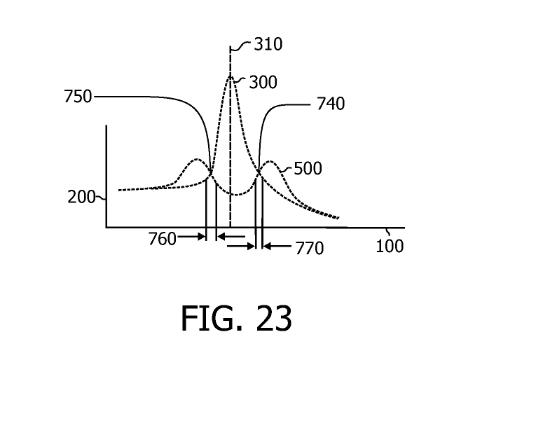

FIG. 23 is an illustration of frequency response curves 300, 500 of a wind turbine tower, according to embodiments that may be combined with other embodiments. The first response 300 (a stiffened and/or locked damper) and second response 500 (a reduced stiffness and/or unlocked damper) are shown. First and second reference ranges 760, 770, are shown that are near and/or envelope the intersections 750, 740, respectively. A reference frequency can be for example a frequency of the first and second reference frequency ranges 760, 770, and can be used to form the comparison with the operational frequency to determine whether to adjust the stiffness of the damper, for example to lock or unlock it and/or to adjust the response of the wind turbine, and/or adjust the stiffness of the damper. For example, the reference ranges 760, 770 include frequencies within a margin of error of the intersections 750, 740, respectively. Typical margins of error are approximately from 0.5% to 2% of the full width at half max (FWHM) of the resonance peak 310, or even up to 50% of the FWHM and higher, noting that the centers of each of the ranges 760, 770 coincides better with the intersections than the peak 310. An advantage of low margins of error is that the response is kept lower than cases of high margins of error.

Embodiments described herein facilitate the one or more effects of: operating of a wind turbine at a wider range of operational frequencies, and reducing the risk associated with fatigue due to oscillations of wind turbine components, for example the bending motion of the tower. The systems and methods described herein thus increase energy production while providing for reduced risk of failure and/or damage. Embodiments described herein can provide allowed operational frequencies on and over the tower natural frequency. Furthermore, embodiments can: reduce the response at the tower natural frequency; allow the natural frequency of the tower to overlap the 1 P and 3 P ranges; no longer require curtailment at the two resonances that often or always result when a tuned mass damper is included in a wind turbine; extends the available frequency range; increases energy production (such as annual energy production); and/or saves costs of additional controllers and accelerometers of active tuned mass dampers.

Exemplary embodiments of systems and methods for wind turbines are described above in detail. The systems and methods are not limited to the specific embodiments described herein, but rather, components of the systems and/or steps of the methods may be utilized independently and separately from other components and/or steps described herein. For example, dampers are not limited to practice with only the wind turbine systems as described herein. Rather, the exemplary embodiment can be implemented and utilized in connection with many other rotor blade applications.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. While various specific embodiments have been disclosed in the foregoing, those skilled in the art will recognize that the spirit and scope of the claims allows for equally effective modifications. Especially, mutually non-exclusive features of the embodiments described above may be combined with each other. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A wind turbine, comprising:
a rotor arranged at a nacelle;
the nacelle supported by a tower; and,
a damper adapted for variably adjusting a frequency response of the tower;
wherein,
the damper includes a movable mass.

2. The wind turbine of claim 1, further comprising:
a controller adapted to select the frequency response of the tower for adjusting the damper.

3. The wind turbine of claim 1, wherein
the damper is tunable to a natural frequency of the tower.

4. The wind turbine of claim 1, wherein
the damper is an adjustable tuned mass damper.

5. The wind turbine of claim 1, wherein
the damper has a variable stiffness which is adjusted in correspondence with the frequency response of the tower.

6. The wind turbine of claim 1, further comprising:
a locking mechanism for the damper, wherein
the locking mechanism is adapted to immobilize the movable mass of the damper when the damper is locked.

7. The wind turbine of claim 6, wherein
the damper is adapted to be locked by the locking mechanism to increase stiffness; and,
the damper is adapted to be unlocked to decrease stiffness.

8. The wind turbine of claim 6, wherein
the locking mechanism is adapted to immobilize the movable mass by activation of a piston, a valve, an inflatable stopper, or combinations thereof.

9. The wind turbine of claim 7, wherein
the damper is adapted to be locked by the locking mechanism when the wind turbine is operated within a first range of operational frequencies; and,
the damper is adapted to be unlocked by the locking mechanism when the wind turbine is operated within a second range of operational frequencies.

10. The wind turbine of claim 9, wherein
the operational frequencies are defined by at least one of a rotor rotational frequency and a blade passing frequency.

11. A wind turbine, comprising:
a rotor arranged at a nacelle;
the nacelle supported by a tower; and,
a damper; wherein,
the damper includes a movable mass and a stiffness adjustment mechanism.

12. The wind turbine of claim 11, wherein
the stiffness adjustment mechanism is a piston, a valve, an inflatable stopper, or combinations thereof.

13. The wind turbine of claim 11, wherein
the damper is tunable to a natural frequency of the tower.

14. The damper assembly of claim 11, wherein
the stiffness adjusting mechanism comprises a locking mechanism, wherein
the locking mechanism is adapted to immobilize the movable mass of the damper when the damper is locked.

15. The wind turbine of claim 14, wherein
the damper is adapted to be locked by the locking mechanism when the wind turbine is operated within a first range of operational frequencies; and, wherein
the damper is adapted to be unlocked by the locking mechanism when the wind turbine is operated within a second range of operational frequencies.

16. The wind turbine of claim 15, wherein
the first and second ranges of operational frequencies are defined by at least one of a rotor rotational frequency, and a blade passing frequency.

17. The wind turbine of claim 15, wherein
the second range of operational frequencies is near a resonance of the wind turbine tower when the damper is locked.

18. A method of operating a wind turbine, the wind turbine comprising a rotor arranged at a nacelle, the nacelle supported by a tower, and a damper including a movable mass; the method comprising:
a) operating the wind turbine at an operational frequency;
b) comparing the operational frequency to a reference frequency to form a comparison; and,
c) adjusting the damper according to the comparison.

19. The method of operating a wind turbine of claim 18, wherein adjusting the damper includes at least one of increasing or decreasing a stiffness of the damper.

20. The method of operating a wind turbine of claim 18, wherein
adjusting the damper includes at least one of unlocking the damper and locking the damper.
